(19) United States
(12) Patent Application Publication
(10) Pub. No.: US 2002/0154030 A1
(43) Pub. Date: Oct. 24, 2002

(54) Sensor element

(76) Inventor: Lothar Diehl, Stuttgart (DE)

Correspondence Address: KENYON & KENYON, ONE BROADWAY, NEW YORK, NY, 10004, US

(21) Appl. No.: 10/045,710

(22) Filed: Jan. 14, 2002

(30) Foreign Application Priority Data
Jan. 13, 2001 (DE) 101 01 351.5-52

(51) Int. Cl. G08B 21/00

(52) U.S. Cl. 340/870.16; 340/870.17

(57) ABSTRACT

A sensor element is secured in a housing by a sealing packing, for example, and has a measurement area and a lead wire area. At least one lead wire having a first electric resistance with a positive temperature coefficient to a measurement device arranged in the measurement area is provided in the lead wire area of the sensor element. The lead wire area has at least one second electric resistance having a negative temperature coefficient. The first resistance and the second resistance as well as a third resistance of the measurement device enter into a total resistance. The temperature coefficients of the first and second resistances are coordinated so that the total resistance remains at least approximately constant when there is a change in the temperature distribution in the lead wire area of the sensor element.

### FIELD OF THE INVENTION

The present invention relates to a sensor element.

### BACKGROUND INFORMATION

Such sensor elements are known to those skilled in the art. These sensor elements contain a measurement area having a measurement device and a lead wire area in which the lead wires to the measurement device are arranged. The measurement device may be, for example, an electrochemical cell having a first electrode, a second electrode and a solid electrolyte arranged between the first and second electrodes. In the lead wire area of the sensor element, a first lead wire is guided to the first electrode and a second lead wire is guided to the second electrode. The sensor element is secured in a housing, for example, by a sealing packing, and the housing is secured in a measurement opening of an exhaust gas pipe.

The electric resistance of the lead wires and that of the measurement device form a total resistance of the sensor element which can be determined, for example, by an electronic analyzer located outside the sensor element. In the case of the sensor elements described here, the resistance of the measurement device often forms a measured variable or a control variable. The resistance of the measurement device can be determined from the total resistance if the resistance of the lead wires is known. If the housing is exposed to temperature fluctuations, these temperature fluctuations are transmitted through the sealing packing, for example, to the lead wire area of the sensor element and thus to the lead wires of the electrodes of the measurement device. If the resistance of the lead wires has a positive or negative temperature coefficient and thus depends on temperature, it varies with a change in temperature in the lead wire area and thus no longer matches the known setpoint. The total resistance thus changes due to the contribution of the resistance of the lead wires. It is therefore no longer possible for the electronic analyzer to correctly determine the resistance of the measurement device and thus the measured variable or control variable.

German Published Patent Application No. 198 38 456 describes a gas sensor having a housing in which a sensor element is secured by a sealing packing. The gas sensor is arranged in the measurement opening of an exhaust gas pipe. In a measurement area, the sensor element has as the measurement device a Nernst cell having a first electrode arranged in a measurement gas space, a second electrode arranged in a reference gas space and a solid electrolyte body arranged between the first and second electrodes. A first lead wire to the first electrode and a second lead wire to the second electrode are provided in a lead wire area of the sensor element. Another solid electrolyte body is arranged between the first and second lead wires.

To achieve the required ionic conductivity of the solid electrolyte body, the sensor element in the measurement area is heated with a heating element to a setpoint temperature in the range of approximately 500 to 800 degrees Celsius. If the actual temperature of the measurement area of the sensor element differs from the setpoint temperature, this has a negative effect on the measurement signal of the sensor element and thus the measurement accuracy is reduced. Since there are great fluctuations in the temperature of the exhaust gas surrounding the sensor element, the operating temperature of the measurement area must be regulated. It is known in this regard that the temperature should be measured in the measurement area of the sensor element, and the heating device should be turned on or off depending on the result of this measurement, thereby regulating the setpoint temperature.

To determine the temperature of the measurement area, the sensor element receives an a.c. voltage, and a total a.c. voltage resistance is determined with an electronic analyzer located outside the sensor element. The a.c. voltage is applied between the first and second lead wires. The total a.c. voltage resistance is composed of the a.c. voltage resistance of the measurement device, which includes the resistances of the first and second electrode and that of the solid electrolyte body in the measurement area, the a.c. voltage resistances of the first and second lead wires and the a.c. voltage resistance of the solid electrolyte body in the lead wire area. From the total a.c. voltage resistance, the electronic analyzer can determine the temperature-dependent a.c. voltage resistance of the measurement device and thus the temperature of the sensor element in the measurement area.

The temperature regulation described here can be disturbed by a change in temperature of the lead wire area. Through contact of the housing with the hot exhaust gas pipe, temperatures of up to 600 degrees Celsius can occur in the lead wire area of the sensor element. The a.c. voltage resistance of the first and second lead wires makes only a negligible contribution to the total a.c. voltage resistance. Accordingly, the change in the a.c. voltage resistance of the first and second electrode when there is a change in temperature distribution in the lead wire area can also be disregarded. The a.c. voltage resistance of the solid electrolyte body in the lead wire area which is connected in parallel with the a.c. voltage resistance of the solid electrolyte body in the measurement area has a negative temperature coefficient and makes a non-negligible contribution to the total a.c. voltage resistance when there is an increase in temperature in the lead wire area, which can thus falsify the temperature measurement and lead to a faulty temperature regulation.

### SUMMARY OF THE INVENTION

The sensor element according to the present invention has the advantage over the related art that a change in temperature distribution in the lead wire area has little or no effect on the total resistance of the sensor element.

A negative effect on the function of the sensor element due to a change in temperature distribution in the lead wire area is prevented by the fact that a resistance having a positive temperature coefficient and a resistance having a negative temperature coefficient are provided in the lead wire area and are coordinated so that a temperature-induced change in the resistance having a negative temperature coefficient is at least approximately compensated by an opposite, likewise temperature-induced change in the resistance having a positive temperature coefficient.

If a heating element which is regulated by the temperature-dependent total resistance of an electrochemical cell is provided for heating the sensor element in the measurement area, then a change in temperature distribution in the lead wire area of the sensor element will have little or no effect on regulation of the heating element.

It is also advantageous if the temperature dependence of the resistance having a positive temperature coefficient is at least similar to that of the resistance having a negative temperature coefficient. In the case of a resistance having a positive temperature coefficient showing a linear temperature dependence, for example, a resistance having a negative temperature coefficient and also being a linear function of temperature is especially suitable for optimum compensation of the temperature dependence accordingly. However, a total resistance which is largely independent of the temperature distribution in the lead wire area can also be achieved at least in a certain temperature range if the temperature dependence of the resistance having a positive temperature coefficient is different from that of the resistance having a negative temperature coefficient.

### BRIEF DESCRIPTION OF THE DRAWINGS

FIG. 1 shows one embodiment of a sensor element according to the present invention in an exploded diagram.

FIG. 2 shows a resistance network for the embodiment of the gas sensor according to the present invention.

### DETAILED DESCRIPTION

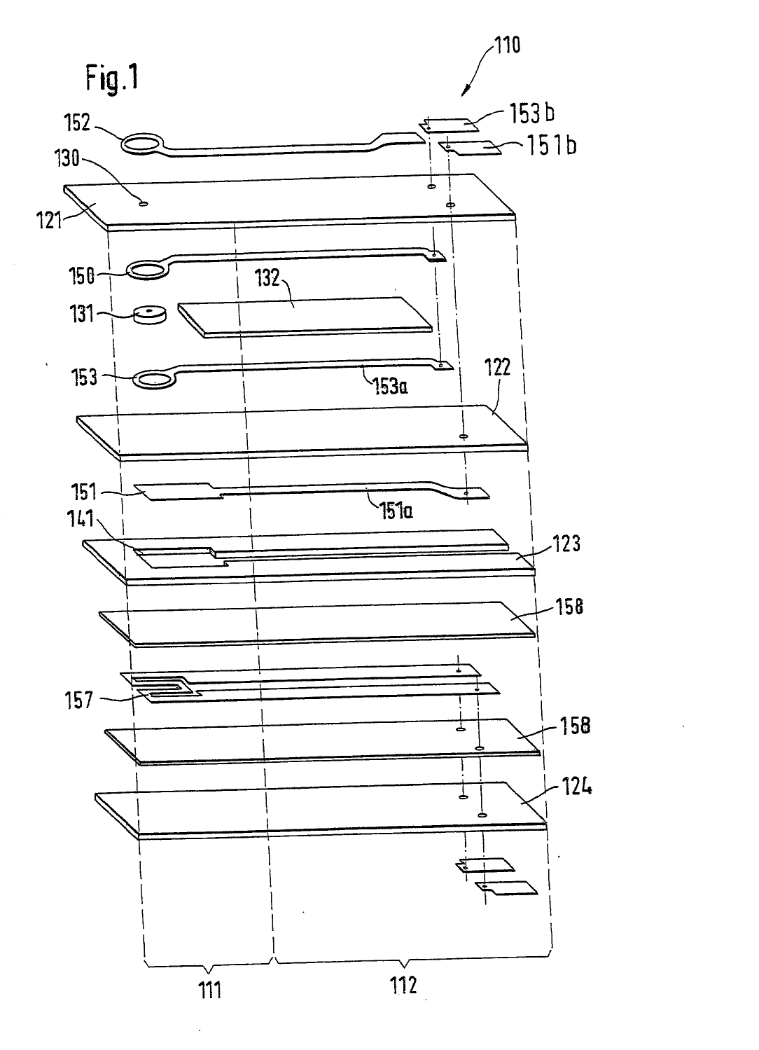

FIG. 1 shows an embodiment of a sensor element 110 having a measurement area 111 and a lead wire area 112. Sensor element 110 is secured in a metal housing of a gas sensor by a sealing arrangement in lead wire area 112. Sensor element 110 is designed as a layered system and has first, second, third and fourth solid electrolyte films 121, 122, 123, 124. A ring-shaped external pump electrode 152 is applied to the surface of first solid electrolyte film 121 facing the exhaust gas. On the side of first solid electrolyte film 121 facing away from outer pump electrode 152, a ring-shaped inner pump electrode 150 is provided in a measurement gas space. Adjacent to first solid electrolyte film 121 is arranged second solid electrolyte film 122 on which is applied a Nernst electrode 153 opposite inner pump electrode 150 in the measurement gas space. To form the measurement gas space, an intermediate layer 132 is arranged between first and second solid electrolyte films 121, 122. Exhaust gas can enter the measurement space through a gas inlet hole 130 and a diffusion barrier 131. A reference electrode 151 is provided on the side of second solid electrolyte film 122 opposite Nernst electrode 153. Reference electrode 151 is arranged in a reference gas space 141 provided in third solid electrolyte film 123. A heating element 157 surrounded by a heating element insulation 158 is provided between third and fourth solid electrolyte films 123, 124.

The oxygen partial pressure prevailing in the measurement gas space is determined by a Nernst cell formed by Nernst electrode 153 and reference electrode 151 as well as the area of second solid electrolyte layer 122 located between Nernst electrode 153 and reference electrode 151. Nernst voltage induced due to different oxygen partial pressures in the measurement gas space and reference gas space 141 is applied to the electrodes of the Nernst cell and can be measured by an electronic analyzer located outside the sensor element and used to determine the partial pressure of the gas component in the measurement gas space.

A pump cell is formed by inner and outer pump electrodes 150, 152 and the area of first solid electrolyte layer 121 located between inner and outer pump electrodes 150, 152. Using the Nernst voltage, the electronic analyzer regulates the pump voltage applied to the pump cell so that a predetermined oxygen partial pressure, e.g., lambda=1, prevails in the measurement gas space. The resulting pump current is limited by the flow of oxygen molecules diffusing through diffusion barrier 131, which in turn depends on the partial pressure of the gas component in the exhaust gas. The partial pressure of the gas component in the exhaust gas can thus be determined from the pump current. A temperature-dependent change in the diffusion resistance of diffusion barrier 131 can therefore have a direct effect on the measurement result obtained with the gas sensor.

Heating element 157 heats measurement area 111 of sensor element 110. For regulation of heating element 157 by an electronic analyzer located outside sensor element 110, an a.c. voltage is applied between a contact surface 153b, which is connected electrically by through-plating to lead wire 153a of Nernst electrode 153, and a contact surface 151b which is also connected electrically by through-plating to lead wire 151a of reference electrode 151, and the total a.c. voltage resistance is determined. In the remaining description of this embodiment, the term resistance should be understood to refer to a.c. voltage resistance.

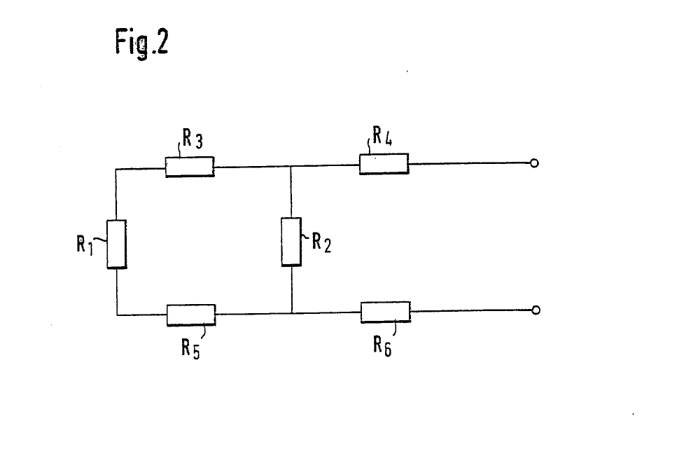

FIG. 2 shows a simplified diagram of the individual resistances forming the total resistance, where R₁ is the resistance of second solid electrolyte film 122 in the area of the Nernst cell, and R₂ is the resistance of second solid electrolyte film 122 in lead wire area 112. Since the resistance of a solid electrolyte drops greatly with an increase in temperature and since resistance R₂ is connected in parallel, resistance R₂ is determined by the warmest area in lead wire area 112, while the contribution of the colder areas is low. R₄ and R₆, and also R₃ and R₅ denote the resistances of lead wires 153a, 151a of Nernst electrode 153 and reference electrode 151 upstream and downstream, respectively, from the hottest area in lead wire area 112 and thus upstream and downstream, respectively, from resistance R₂.

When the housing is cold, resistance R₂ makes only a negligible contribution to the total resistance, so that total resistance Rₜₒₜₐₗ is obtained from

Rₜₒₜₐₗ=R₄+R₃+R₁+R₅+R₆.

In heating of sensor element 110 in lead wire area 112 due to a hot housing, resistance R₂ can no longer be negligible, thus yielding for total resistance Rₜₒₜₐₗ

$${R}_{total} = {R}_{4} + {R}_{6} + \frac{{R}_{2} ( {R}_{3} + {R}_{1} + {R}_{5} )}{{R}_{2} + {R}_{3} + {R}_{1} + {R}_{5}}$$

Resistances R₃, R₄, R₅ and R₆ can be combined as a first resistance, which has a positive temperature coefficient in the embodiment described here. For simplification, let us assume below that resistances R₃, R₄, R₅ and R₆ are the same. Resistance R₂ of the solid electrolyte body in the lead wire area forms a second resistance, and the resistance of the measurement device, i.e., in this case the resistance of solid electrolyte body R₁ in the measurement area, forms a third resistance. The second and third resistances have a negative temperature coefficient.

The first and second resistances are then coordinated so that the reduction in the second resistance with an increase in temperature in lead wire area 112 is compensated by an increase in the first resistance resulting from the increase in temperature in the lead wire area. Thus, the total resistance remains largely unchanged with an increase in temperature in lead wire area 112.

In the present embodiment, the setpoint temperature in measurement area 111 is approximately 800 degrees. The setpoint temperature in measurement area 111 should not have any dependence on the temperature in lead wire area 112. Resistance R₁ of second solid electrolyte film 122 in measurement area 111 amounts to approximately 60 ohm. Resistance R₂ of second solid electrolyte film 122 in lead wire area 112 amounts to approximately 300 ohm in the case of a hot housing and is so great when the housing is cold that the contribution to the total resistance is negligible. Resistances R₃, R₄, R₅ and R₆ of lead wires 151a, 153a are selected so that each amounts to approximately 10 ohm when the housing is cold, and each amounts to approximately 15 ohm when the housing is hot. The total resistance thus remains approximately the same regardless of whether the housing is hot or cold.

The determination of the optimum resistance of lead wires 151a, 153a derived from the simplified resistance network illustrated in FIG. 2 is intended only to illustrate the general functioning of the present invention. Various factors such as the geometry of the housing, sensor element 120 and lead wires 151a, 153a as well as the temperatures of the housing occurring during operation, the heat transfer from the housing to sensor element 110 and the resulting temperature distribution in sensor element 110 enter into the dependence of the total resistance on the temperature of sensor element 110 in lead wire area 112. The optimum resistance of lead wires 151a, 153a depends on these factors and cannot be specified in general. The assumption that resistances R₃, R₄, R₅ and R₆ are the same is not correct for all sensor elements. However, those skilled in the art could easily determine the optimum resistance for lead wires 151a, 153a through experiments. The resistance of lead wires 151a, 153a can be influenced, for example, by adjusting the cross-sectional area of lead wires 151a, 153a, e.g., through double pressure or by making lead wires 151a, 153a thicker. The desired resistance of lead wires 151a, 153a may naturally also be achieved by adjusting the composition of lead wires 151a, 153a. For example, in the case of a lead wire 151a, 153a made of a cermet, the amount of ceramic component may be altered. It is also conceivable for the metallic component of the cermet to have an alloy of platinum with at least one other noble metal such as an alloy of platinum and palladium in which the palladium content of the metallic component of the cermet is in the range of 2 to 50 percent by weight, preferably 10 percent by weight. In the case of the material of lead wires 151a, 153a, the temperature dependence of the resistance of these materials should not be too low, so that the temperature-induced change in resistance of the solid electrolyte body can be compensated.

It is also conceivable for the resistance to be different in some sections within lead wire 151a, 153a. For example, in the area of lead wire area 112, which is heated to the greatest extent through the sealing packing when the housing is hot, a section of lead wires 151a, 153a having a higher resistance than the sections of lead wires 151a, 153a in the colder areas of lead wire area 112 could be provided.

It is also conceivable for the resistances having positive and negative temperature coefficients in the lead wire area to be connected in series. The present invention can also easily be applied to other circuit arrangements and/or other types of sensors, such as a temperature sensor.

What is claimed is:

1. A sensor element, comprising:
a measurement area;
a lead wire area;
a measurement device arranged in the measurement area; and
at least one lead wire having a first electric resistance to the measurement device and being provided in the lead wire area, wherein:
the first electric resistance has a positive temperature coefficient in at least some areas,
the lead wire area has at least one second electric resistance that has a negative temperature coefficient,
at least the first electric resistance, the at least one second electric resistance, and a third electric resistance of the measurement device form a total resistance, and
the positive temperature coefficient and the negative temperature coefficient are coordinated so that the total resistance remains at least approximately constant when there is a change in a temperature distribution in the lead wire area.

2. The sensor element according to claim 1, wherein:
the sensor element is disposed in a gas sensor for determining a physical quantity of a gas component in an exhaust gas of an internal combustion engine.

3. The sensor element according to claim 1, wherein:
the measurement device includes a first electrode and a second electrode in the measurement area of the sensor element and a solid electrolyte arranged between the first electrode and the second electrode,
a first lead wire of the at least one lead wire leads to the first electrode,
a second lead wire of the at least one lead wire leads to the second electrode,
the first lead wire and the second lead wire are arranged in the lead wire area, and
the solid electrolyte is arranged between the first lead wire and the second lead wire.

4. The sensor element according to claim 3, wherein:
the first electric resistance having the positive temperature coefficient is formed by resistances of the first lead wire and the second lead wire,
the at least one second electric resistance having the negative temperature coefficient corresponds to a resistance of the solid electrolyte body between the first lead wire and the second lead wire, and
a resistance of the first electrode, a resistance of the second electrode, and the resistance of the solid electrolyte in the measurement area enter into the third resistance.

5. The sensor element according to claim 1, wherein:
the sensor element is secured in a housing, and
the change in the temperature distribution in the lead wire area can be attributed to a heating of the housing.

6. The sensor element according to claim 3, wherein:
in a portion of the lead wire area that is subject to a greatest heating, a section of the first lead wire and a section of the second lead wire having a higher resistance in comparison with a resistance of the first lead wire and a resistance of the second lead wire outside the sections of the first lead wire and the second lead wire are provided.

7. The sensor element according to claim 1, further comprising:
a heating element that heats up the sensor element in the measurement area to a predetermined temperature and enters into a regulation of the total resistance.

8. The sensor element according to claim 3, wherein:
the total resistance is determined by applying an a.c. voltage between the first lead wire and the second lead wire, and
a total a.c. voltage resistance is determined by an electronic measurement device arranged outside the sensor element.

9. The sensor element according to claim 7, wherein:
the predetermined temperature in the measurement area remains at least largely constant when there is the change in the temperature distribution because of an external influence acting on the lead wire area.

10. The sensor element according to claim 3, wherein:
the first electrode, the second electrode, and the solid electrolyte form an electrochemical cell,
the first electrode is a Nernst electrode arranged in a measurement gas space, and
the second electrode is a reference electrode arranged in a reference gas space.

11. The sensor element according to claim 10, wherein:
the electrochemical cell includes a Nernst cell of one of a broadband probe and a lambda probe.

12. The sensor element according to claim 3, wherein:
the first lead wire and the second lead wire include in at least some areas thereof a cermet containing Al₂O₃ as a ceramic component and containing platinum and palladium as metallic components, and
a palladium content is 2 to 50 percent by weight based on the metallic components of the cermet.

13. The sensor element according to claim 12, wherein:
the palladium content is 10 percent by weight.
